(19) United States
(12) Patent Application Publication
(10) Pub. No.: US 2017/0075581 A1
(43) Pub. Date: Mar. 16, 2017

(54) CONTROL DEVICE AND INFORMATION PROCESSING SYSTEM

(71) Applicant: FUJITSU LIMITED, Kawasaki-shi (JP)

(72) Inventors: Kenji IWASAWA, Nagano (JP); Masakazu SAKAMOTO, Nagano (JP); Hiroyuki HOSHINO, Nagano (JP); Yusuke KURASAWA, Nagano (JP)

(73) Assignee: FUJITSU LIMITED, Kawasaki-shi (JP)

(21) Appl. No.: 15/244,777

(22) Filed: Aug. 23, 2016

(30) Foreign Application Priority Data
Sep. 11, 2015 (JP) 2015-179376

(51) Int. Cl. G06F 3/06

(52) U.S. Cl. CPC G06F 3/0604; G06F 3/0638; G06F 3/0673

(57) ABSTRACT

A control device includes a memory device and a processor. The memory device is configured to store therein log information obtained by accumulating logs received from an apparatus. The logs relate to a plurality of processes. The processor is configured to determine on basis of the log information and preset expectation information whether the plurality of processes are normally terminated in a case where the log information includes information indicating that the plurality of processes are normally terminated. The expectation information includes first state information in association with expected state information. The first state information indicates a first state of an object before execution of the plurality of processes. The expected state information indicates an expected state of the object after the execution. The processor is configured to write the log information into a storage device upon determining that the plurality of processes are abnormally terminated.

### CROSS-REFERENCE TO RELATED APPLICATION

This application is based upon and claims the benefit of priority of the prior Japanese Patent Application No. 2015-179376, filed on Sep. 11, 2015, the entire contents of which are incorporated herein by reference.

### FIELD

The embodiment discussed herein is related to a control device and an information processing system.

### BACKGROUND

In various information processing systems such as a storage device, it is known that various logs are accumulated in a control device such as, for example, a controller module (CM) of a storage device, and stored in a non-volatile memory device. In a case where a failure is occurred in an information processing system, inspection information is extracted from the logs stored in a memory device, and the inspection or analysis of a failure cause is performed.

In addition, in a control device, various operations are performed from a terminal device such as a server or a personal computer (PC) for performing maintenance, management, or the like, and the control device also stores information of logs (operation logs) relating to such operations in a memory device.

Related techniques are disclosed in, for example, Japanese Laid-Open Patent Publication No. 2014-146074, Japanese Laid-Open Patent Publication No. 2014-102717, and International Publication Pamphlet No. WO 2007/074680.

Due to the limited capacity of a log storage area, it is difficult to continue to constantly store data used in an inspection or analysis. For this reason, in a case where a failure is occurred in an information processing system, the data used in the inspection or analysis of a failure cause may be lost, and it is difficult to identify the cause in many cases. Examples of the data used in the inspection or analysis of a failure cause include contents of user operations, contents of data communicated with other modules, internal control data, and the like.

The data used in an inspection or analysis may be temporarily accumulated in a memory area, and the accumulated data is written in a log storage area when a failure is occurred. As a result, the data used in the inspection or analysis may be prevented from being lost. However, the accumulation of such data in a memory may press the memory area and there is possibility that the processing of ordinary operations may be influenced. Therefore, this forces a modification to hardware of a device, such as the expansion of a memory area for accumulating the data.

In the process of operating from the terminal device to the control device, in a case where the contents displayed on, for example, the graphical user interface (GUI) screen of the terminal device are abnormal, an operator of the terminal device visually checks whether the contents are abnormal. In this case, since the processing itself is normally terminated in the control device, a process of writing data, which is accumulated in a memory to be used in an inspection or analysis, into a log storage area is not performed, and thus the data used in the inspection or analysis of a failure cause may be lost.

### SUMMARY

According to an aspect of the present invention, provided is a control device including a memory device and a processor. The memory device is configured to store therein log information obtained by accumulating logs received from an apparatus. The logs relate to a series of a plurality of processes executed by the apparatus. The processor is configured to receive the logs from the apparatus. The processor is configured to accumulate the received logs to obtain the log information. The processor is configured to store the obtained log information into the memory device. The processor is configured to determine on basis of the log information and preset expectation information whether the plurality of processes are normally terminated in a case where the log information includes information indicating that the plurality of processes are normally terminated. The expectation information includes first state information in association with expected state information. The first state information indicates a first state of an object before execution of the plurality of processes. The expected state information indicates an expected state of the object after the execution of the plurality of processes. The processor is configured to write the log information into a storage device different from the memory device upon determining that the plurality of processes are abnormally terminated.

The object and advantages of the invention will be realized and attained by means of the elements and combinations particularly pointed out in the claims. It is to be understood that both the foregoing general description and the following detailed description are exemplary and explanatory and are not restirctive of the invention, as claimed.

### BRIEF DESCRIPTION OF DRAWINGS

FIG. 1 is a diagram illustrating an exemplary configuration of a storage system according to an embodiment;

FIG. 2 is a diagram illustrating an exemplary hardware configuration of a CM;

FIG. 3 is a diagram illustrating an exemplary functional configuration of the CM;

FIG. 4 is a diagram illustrating an example of a data structure of identifier information;

FIG. 5 is a diagram illustrating an example of a data structure of log information;

FIG. 6 is a diagram illustrating an example of a data structure of normality confirmation information;

FIG. 7 is a flowchart of an exemplary operation of a master CM;

FIG. 8 is a flowchart of an exemplary operation of a transmission destination selection process which is performed by the master CM;

FIG. 9 is a flowchart of an exemplary operation of a slave CM;

FIG. 10 is a flowchart of an exemplary operation of a process of operation normality confirmation which is performed by the slave CM;

FIG. 11 is a diagram illustrating an example of identifier information according to an application example;

FIG. 12 is a diagram illustrating an example of log information according to the application example;

FIG. 13 is a diagram illustrating an example of log information according to the application example;

FIG. 14 is a diagram illustrating an example of log information according to the application example;

FIG. 15 is a diagram illustrating an example of normality confirmation information according to the application example; and

FIG. 16 is a diagram illustrating an example of an expected result according to the application example.

### DESCRIPTION OF EMBODIMENT

Hereinafter, an embodiment of the present disclosure will be described with reference to the accompanying drawings. The embodiment described below is illustrative only, and is not intended to exclude the application of various modifications and techniques which are not clarified below. That is, various modifications of the present embodiment may be implemented without departing from the spirit and scope thereof. In the drawings referred to in the following embodiment, the components assigned by the same reference numerals and signs, unless otherwise stated, represent the same or similar components.

### Embodiment

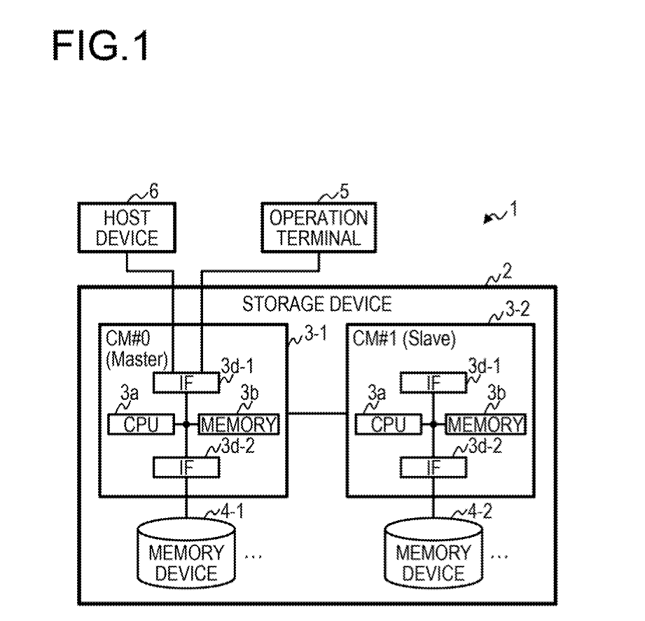

FIG. 1 is a diagram illustrating an exemplary configuration of a storage system 1 according to the embodiment. As illustrated in FIG. 1, the storage system 1 includes a storage device 2, an operation terminal 5, and a host device 6.

The storage system 1 may have a plurality of memory devices (not illustrated) mounted in the storage device 2, and provide storage areas of the memory devices to the host device 6. For example, the storage system 1 may store data in the plurality of storage devices in a distributed or redundant state, using a redundant array of inexpensive disks (RAID).

The storage device 2 is coupled with a housing such as, for example, a drive enclosure (DE) (not illustrated) having a plurality of memory devices mounted therein, and performs various control in accordance with a request from the operation terminal 5 or the host device 6.

As illustrated in FIG. 1, the storage device 2 includes a plurality (two in FIG. 1) of CMs 3-1 and 3-2, and a plurality (two in FIG. 1) of memory devices 4-1 and 4-2. In the following description, in a case where the CMs 3-1 and 3-2 are not distinguished from each other, they are simply referred to as CMs 3. Also, in a case where the memory devices 4-1 and 4-2 are not distinguished from each other, they are simply referred to as memory devices 4.

In the example of FIG. 1, the CM 3 may be provided in a control housing such as a controller enclosure (CE), and the memory device 4 may be provided in a housing such as the CE or the DE. In other words, the memory device 4 may be at least one of the memory devices mounted in the CE of the storage device 2, and may be at least one of the memory devices mounted in the DE.

The CM 3 is an example of a control device that controls a request for access to the DE, which is issued from the host device 6, and controls a request for various operations, which is issued from the operation terminal 5. An example of the CM 3 includes an information processing apparatus such as a computer, for example, a server or a PC.

As illustrated in FIG. 1, the CM 3 is made redundant (duplicated) with another CM 3. One CM 3 (e.g., CM 3-1: also referred to as CM#0) among the CMs 3 serves as a master CM 3 that mainly controls the storage device 2. The CM 3 (e.g., CM 3-2: also referred to as CM#1) other than the master CM 3 serves as a slave CM 3 which is switched to a master when an abnormality is occurred in the master CM 3 or the master CM 3 is separated. The master and slave may be determined when the storage device 2 is started up.

The CMs 3 may perform a communication through a cable, such as a SAS cable, for coupling the CMs 3 with each other. “SAS” is an abbreviation for Serial Attached SCSI (Small Computer System Interface). In addition, a plurality of CMs 3 perform a mutual communication of information, and thus may perform, for example, an information sharing (synchronization) or a notification relating to the control of the storage system 1, an access to the DE, or a log.

The memory device 4 is an example of hardware that stores therein various data, programs, and the like. Examples of the memory device 4 include various memory devices, for example, a magnetic disc device such as a hard disk drive (HDD), a semiconductor drive device such as a solid state drive (SSD), and a non-volatile memory such as a flash memory.

The operation terminal 5 is an example of a terminal device coupled with the CM 3. The operation terminal 5 may issue an operation request for performing various operations to the CM 3.

As an example, the operation terminal 5 may issue an operation request by accessing a uniform resource indicator (URI) of the master CM 3 such as, for example, uniform resource locator (URL) using a scheme of hyper-text transform protocol (HTTP), through a Web browser or the like.

The host device 6 is an example of an upper-level device coupled with the CM 3. The host device 6 may issue an access request for performing various access to the DE (memory device).

Each of the operation terminal 5 and the host device 6 may be an information processing apparatus such as a computer, for example, a server or a PC.

Although not illustrated in the example of FIG. 1, the operation terminal 5 and the host device 6 may also be coupled with the CM 3-2. In addition, the operation terminal 5 and the host device 6 may be coupled with a plurality of CMs 3 through a switch for switching a path between the operation terminal 5 (or the host device 6) and the plurality of CMs 3, or through a network such as a local area network (LAN), the Internet, or the like.

Hereinafter, details of the CM 3 in the storage system 1 will be described.

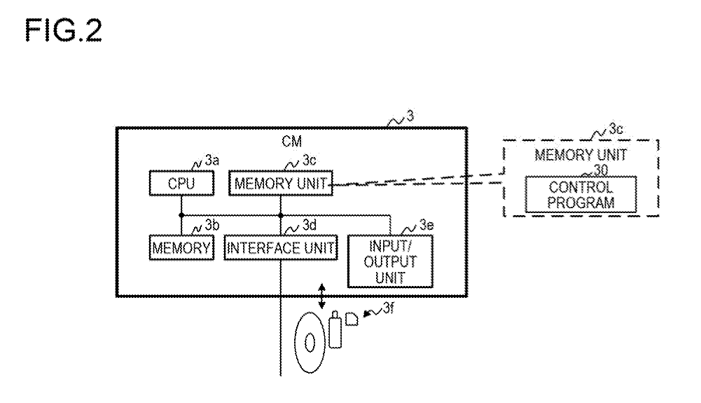

First, an exemplary hardware configuration of the CM 3 illustrated in FIG. 1 will be described with reference to FIGS. 1 and 2. FIG. 2 is a diagram illustrating an exemplary hardware configuration of the CM 3. As illustrated in FIG. 2, the CM 3 may include a central processing unit (CPU) 3a, a memory 3b, a memory unit 3c, an interface unit 3d, and an input/output unit 3e.

The CPU 3a is an example of an arithmetic processing unit (processor) that performs various controls and arithmetic operations. The CPU 3a may be communicably coupled with each block within the CM 3 through a bus. As the arithmetic processing unit, an electronic circuit such as an integrated circuit (IC), for example, a micro processing unit (MPU), an application specific integrated circuit (ASIC), or a field programmable gate array (FPGA) may be used instead of the CPU 3a.

The memory 3b is an example of hardware that stores therein various data and programs. The memory 3b may also be used as a cache memory that temporarily holds data and programs which are used for access to the DE or the like. An example of the memory 3b includes a volatile memory such as a random access memory (RAM).

The memory unit 3c is an example of hardware that stores therein various data, programs, and the like. Examples of the memory unit 3c include various memory devices, for example, a magnetic disc device such as an HDD, a semiconductor drive device such as an SSD, a non-volatile memory such as a flash memory, a read-only memory (ROM), or the like.

For example, the memory unit 3c may store therein a control program 30 for implementing all or some of various functions of the CM 3. For example, the CPU 3a may load the control program 30 stored in the memory unit 3c into the memory 3b and execute the control program 30 to implement the functions of the CM 3.

The interface unit 3d is an example of a communication interface that performs control or the like of connection and communication with another CM 3, the operation terminal 5, the host device 6, the DE, and the like. For example, the interface unit 3d may include IFs 3d-1 and 3d-2 illustrated in FIG. 1. The control program 30 may be downloaded from a network, not illustrated, to the CM 3 through the interface unit 3d.

In the example illustrated in FIG. 1, the IF 3d-1 is an example of a communication interface (host interface) that performs control or the like of connection and communication with the operation terminal 5 or the host device 6. An example of the IF 3d-1 includes one or more channel adapters (CA) provided with an adapter based on LAN, SAS, Fibre Channel (FC), InfiniBand, or the like. The IF 3d-1 may be coupled with the operation terminal 5 or the host device 6 through a cable or the like based thereon.

The IF 3d-2 is an example of a communication interface that performs control or the like of connection and communication with the DE (memory device). The IF 3d-2 may include, for example, a plurality of input output controllers (IOC) and expanders (EXP). The IOC is an example of an I/O control unit that controls an access (I/O) to the DE, and the EXP is an example of a module for expanding the number of devices that may be coupled with and subordinated to the CM 3 (e.g., SAS-connection).

Referring back to FIG. 2, the interface unit 3d may include a reading unit that reads out data and programs recorded in a recording medium 3f. The reading unit may include a connection terminal or a device capable of coupling or inserting the computer-readable recording medium 3f. Examples of the reading unit include an adapter based on universal serial bus (USB), a drive device that performs an access to a recording disc, a card reader that performs an access to a flash memory such as an SD card, and the like. The control program 30 may be stored in the recording medium 3f.

The input/output unit 3e may include at least a portion of an input unit such as a mouse, a keyboard, operation buttons, and an output unit such as a display. For example, the input unit may be used in the registration or change of settings performed by a user, an operator, or the like, various operations such as the mode selection (switching) of a system, or an operation such as input of data. The output unit may be used in the confirmation of settings performed by an operator or the like and the output of various notifications or the like.

The above-described hardware configuration of the CM 3 is illustrative. Therefore, an increase or decrease (e.g., an addition or omission of any block), division, and integration based on any combination of hardware between other CMs 3 or within the CMs 3, the addition or omission of a bus, and the like may be appropriately performed.

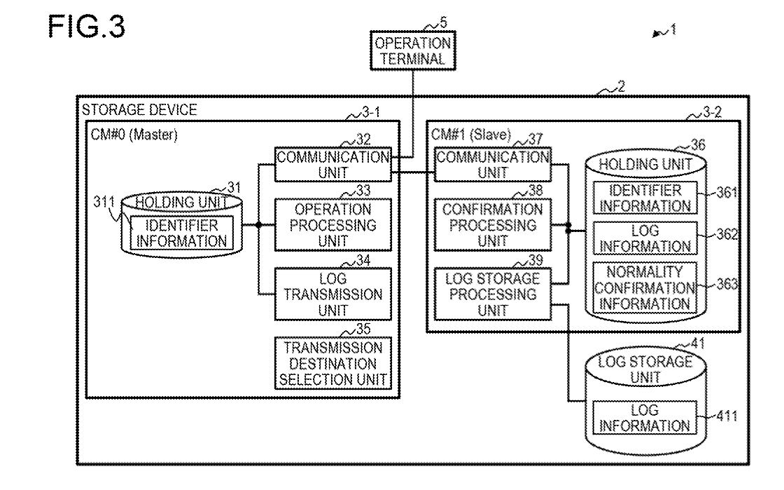

Next, an exemplary functional configuration of the CM 3 according to the embodiment will be described with reference to FIG. 3. FIG. 3 is a diagram illustrating an exemplary functional configuration of the CM 3 illustrated in FIG. 1. In the example of FIG. 3, some of devices, cables, and the like in the storage system 1 illustrated in FIG. 1 are omitted.

Hereinafter, descriptions will be given on a process of collecting and accumulating the logs in the storage device 2 which is redundantly operated by the master CM 3 and the slave CM 3 in a duplex configuration. As an example, descriptions will be given on a case where the master CM 3 performs processes and log collection in response to an operation request and various information received from the operation terminal 5, and the slave CM 3 accumulates and stores the logs relating to the processes performed by the master CM 3.

As illustrated in FIG. 3, the CM 3-1 (CM#0) serving as the master CM 3 includes a holding unit 31, a communication unit 32, an operation processing unit 33, a log transmission unit 34, and a transmission destination selection unit 35. The CM 3-2 (CM#1) serving as the slave CM 3 includes a holding unit 36, a communication unit 37, a confirmation processing unit 38, and a log storage processing unit 39. Further, the memory device 4-2 coupled with the CM 3-2 serving as the slave CM 3 includes a log storage unit 41.

In the example of FIG. 3, a case is illustrated in which, among the plurality of CMs 3 included in the storage device 2, the CM 3-1 serves as the master CM 3, and the CM 3-2 serves as the slave CM 3, but there is no limitation thereto. For example, both the CMs 3-1 and 3-2 may include the functional blocks 31 to 39 of the master and the slave.

Each of the holding units 31 and 36 is an example of a memory unit, and may be implemented with at least a portion of a memory area of the memory 3b illustrated in, for example, FIGS. 1 and 2. The log storage unit 41 is an example of a memory unit different from the holding unit 36, and may be implemented with at least a portion of a memory area of the memory unit 3c illustrated in, for example, FIG. 2.

Each of the communication units 32 and 37 may be implemented with at least a portion of functions of the interface unit 3d and the CPU 3a, which executes the control program 30, illustrated in FIG. 2. The operation processing unit 33, the log transmission unit 34, the transmission destination selection unit 35, the confirmation processing unit 38, and the log storage processing unit 39 may be implemented with at least a portion of the function of the CPU 3a that executes the control program 30.

The holding unit 31 of the master CM 3 includes a memory area for storing identifier information 311. The holding unit 36 of the slave CM 3 includes a memory area for storing identifier information 361, log information 362, and normality confirmation information 363. The log storage unit 41 of the slave CM 3 includes a memory area for storing log information 411. Each piece of the log information 362 and 411 is information obtained by accumulating logs relating to a series of a plurality of processes which are executed by the master CM 3 in response to an operation request. Details of these pieces of information held by the holding units 31 and 36 and the log storage unit 41 will be described later.

The communication unit 32 of the master CM 3 performs various communications with the operation terminal 5 and the slave CM 3.

The operation processing unit 33 of the master CM 3 performs various processes in response to the operation request and information such as an operation object or parameters which are received from the operation terminal 5. Examples of the operation request with respect to RAID, a disc (memory device of the DE), or the like include the capacity expansion of RAID, the creation of a volume on RAID, the separation of a disc from RAID, the incorporation of a module such as a disc, a controller, or a CM 3 degenerated due to abnormality, and the like. In this manner, the operation request may include a request for performing various logical or physical operations.

The operation processing unit 33 displays a screen for specifying an operation object, inputting parameters, or the like on the Web browser of the operation terminal 5 through, for example, the communication unit 32, and executes a process relating to the operation request when information which is input or selected on a screen is received from the operation terminal 5.

When the series of the plurality of processes in response to the operation request is completed, and then a notice that the processes are abnormal is given from the slave CM 3, the operation processing unit 33 may display on the operation terminal 5 the occurrence of abnormality to notify an operator of the occurrence of abnormality. In this case, since there is possibility that the master CM 3 or a device serving as the operation object enters into an unexpected abnormal state, the master CM or the device may be guarded so as not to be performed the subsequent setting operation through the operation terminal 5, for example, may be managed as an operation disabled state.

The series of the plurality of processes executed by the master CM 3 in response to the operation request may include a process of acquiring the state of a processing object and a process of changing the state of the processing object. For example, an example of the process of acquiring the state of the processing object includes a process of receiving information of the processing object, input parameters, or the like from the operation terminal 5, and the process of changing the state of the processing object includes an actual setting process for the processing object.

The log transmission unit 34 of the master CM 3 collects information received from the operation terminal 5, information relating to a process performed by the operation processing unit 33, or the like, and transmits the collected information as an operation log (hereinafter, simply referred to as a log in some cases) to the slave CM 3 through the communication unit 32. The operation log is an example of data used in inspection and analysis in a case where a failure is occurred, and includes, for example, operation data, control data, a processing result, and the like.

As an example, the “operation data” is input information such as an operation object or input parameters relating to an operation requested from the operation terminal 5. The “control data” is information including “command data” and “internal control data”. The “command data” is a command relating to an operation content requested in the operation request, and the “internal control data” is internal control data in the CM 3 such as, for example, control data for performing table construction or the like. The “processing result” is information including a result of the master CM 3 determining whether the processes are normally terminated or abnormally terminated with respect to a series of operation requests from the operation terminal 5.

In the transmission of a log to the slave CM 3 by the log transmission unit 34, an identifier may be added to the log to be transmitted. The identifier is unique information for identifying a function, an operation, data contents, and the like. The identifiers which are added to logs are preferably shared between the master CM 3 and the slave CM 3 as the identifier information 311 and 361.

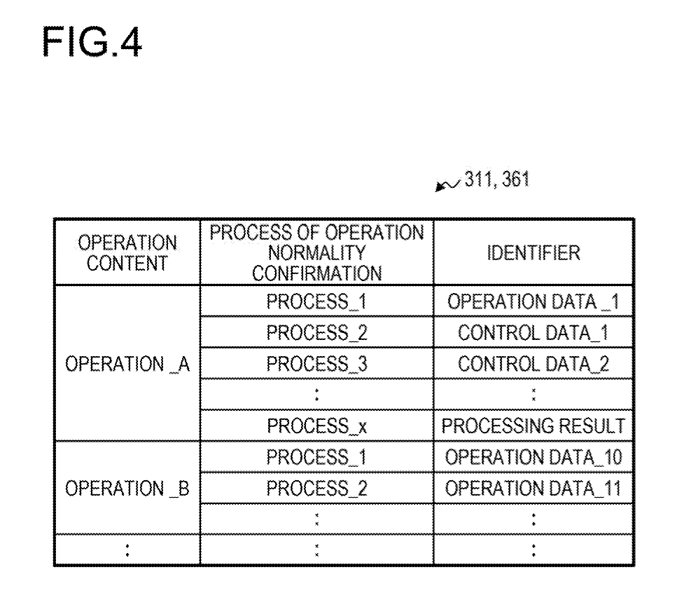

As illustrated in FIG. 4, an operation content, a process of operation normality confirmation, and an identifier are set in the identifier information 311 and 361. The operation content is a content (function) of an operation request, such as, for example, RAID capacity expansion or disc separation, which may be issued from the operation terminal 5. The process of operation normality confirmation is information indicating the contents of each of a series of a plurality of processes performed by the master CM 3 in response to the operation request represented in the operation content.

As the identifier, for example, “01000001” (Operation Data_1) may be set in Process_1 of Operation_A, “01000002” (Control Data_1) may be set in Process_2 of Operation_A, “02010001” may set in Process_1 of Operation_B, and the like. In the identifier, for example, an area for identifying an operation content and an area for identifying a process is preferably separated from each other. For example, settings are performed so that leading two digits indicate an operation content, and the remainders indicate a process. Thereby, it is possible to easily identify an operation content from the identifier in the slave CM 3 so that, for example, “01” indicates a RAID capacity expansion and “02” indicates a disc separation.

The log transmission unit 34 may add, to a log to be transmitted, an identifier corresponding to an “operation content” and a “process of operation normality confirmation” relating to the log, for example, with reference to the identifier information 311, and transmit the log added with the identifier to the slave CM 3.

In addition, when the processing result is transmitted to the slave CM 3, the log transmission unit 34 may transmit the current state information of the device, which is held by the master CM 3-1, to the slave CM 3 together with the result. The current state information of the device may include one or more pieces of information such as the overall state of the storage device 2 and the hardware state or the logical (e.g., “formatting”) state of a device serving as an operation object, that is, an individual part such as RAID, a disc, or the like.

In a case where the storage device 2 is provided with a plurality of slave CMs 3, the transmission destination selection unit 35 of the master CM 3 selects a slave CM 3 which is a transmission destination of the transmission by the log transmission unit 34.

The storage device 2 according to the embodiment may include a plurality of slave CMs 3. In a case where the plurality of slave CMs 3 are present within the storage device 2, the log transmission unit 34 may transmit the operation data and the control data to all the slave CMs 3 to maintain redundancy. With that, even in a case where a failure in a slave CM 3 is occurred during a process for the operation request, other slave CMs 3 may continue a process of confirming operation normality.

However, when the log information 411 is written into the log storage unit 41 of the memory device 4 in all the slave CMs 3, identical log information 411 is written in a plurality of slave CMs 3, and thus, a log storage area is uselessly consumed. In addition, in a case where a slave CM 3 is restored from a failure state during a process in response to an operation request, or a change from the master CM 3 to the slave CM 3 occurs, there is also possibility of the log information 362 not being sufficiently accumulated in a log accumulation area of holding unit 36 of the slave CM 3.

Consequently, in a case where the log transmission unit 34 transmits the operation data or the control data, the transmission destination selection unit 35 stores response data received from the slave CM 3. The response data includes information indicating the accumulation status of the log information 362 in the slave CM 3. When the log transmission unit 34 transmits the processing result, the transmission destination selection unit 35 selects one slave CM 3 as a CM 3 of a transmission destination on the basis of the response data, from the slave CMs 3 in a normal state, and causes the log transmission unit 34 to transmit the processing result to the selected slave CM 3.

For example, the slave CM 3 may notify the master CM 3 of the amount of data accumulated in the log accumulation area of the holding unit 36 while the amount is included in the response data. In this case, the transmission destination selection unit 35 may select a slave CM 3 having the largest amount of data accumulated in the log accumulation area.

As another example, the slave CM 3 may notify the master CM 3 of a time stamp of an oldest (received first) log in a series of log information 362 received from the master CM 3 while the time stamp is included in the response data. In this case, the transmission destination selection unit 35 may select a slave CM 3 having an oldest time stamp.

In a case where a plurality of slave CMs 3 having the largest amount of data or having the oldest time stamp are present (in a case where a plurality of slave CMs 3 to be selected are present), the transmission destination selection unit 35 may select, for example, a CM 3 of which the part number is earliest. Alternatively, in a case where a plurality of slave CMs 3 to be selected are present, the plurality of slave CMs 3 may be selected as transmission destinations, in preparation for a failure in the memory device 4.

In this manner, even in a case where a failure in a slave CM 3 is occurred during a process in response to an operation request, it is possible to continue the process in other slave CMs 3 to confirm operation normality. In addition, it is possible to prevent the log storage area of the log storage unit 41 from being uselessly consumed in a plurality of slave CMs 3 thereby efficiently using a resource.

The slave CM 3 serving as a transmission destination of the operation data and the control data of the log transmission unit 34 is not limited to the above description. For example, even in a case where a plurality of slave CMs 3 are present in the storage device 2, the transmission destination may be limited to some of CMs 3 among these slave CMs 3.

In a case where only one slave CM 3 is present in the storage device 2, or in a case where the transmission destination of the operation data and the control data is one slave CM 3 even when a plurality of slave CMs 3 are present, the function of the transmission destination selection unit 35 may be omitted in the master CM 3.

The communication unit 37 of the slave CM 3 performs various communications with the master CM 3.

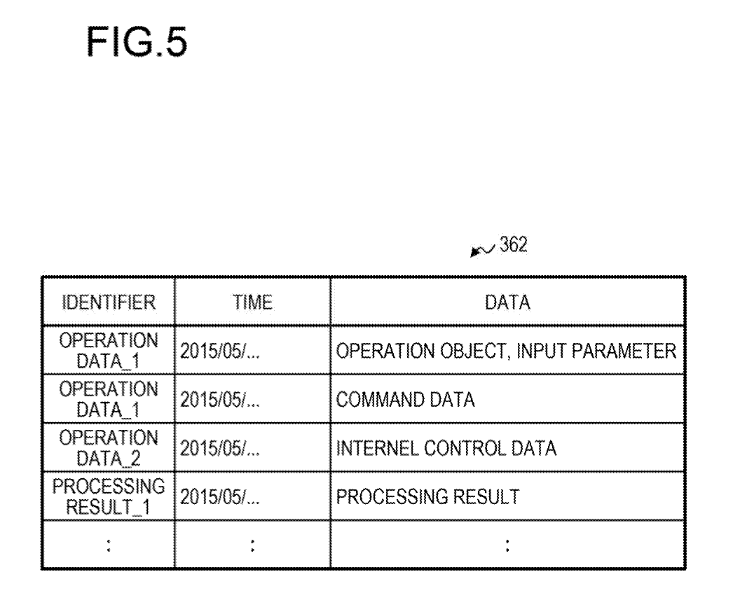

When a log is received from the master CM 3, the communication unit 37 may accumulate the received log as the log information 362 in the holding unit 36. As illustrated in FIG. 5, the identifier added to the log, the reception time of the log, and the data of the log are set in the log information 362.

When a log is received from the master CM 3, the communication unit 37 may transmit information relating to the accumulation status of the log information 362, described above, as the response data.

The log information 362 relating to a series of a plurality of processes from the master CM 3 may include a log of each of the plurality of processes executed by the master CM 3 in response to the operation request of the operation terminal 5. Identifiers are added to these logs by the master CM 3, as described above.

When a log relating to the processing result is received from the master CM 3, the confirmation processing unit 38 confirms, on the basis of the log information 362, whether a series of processes performed in the master CM 3 in response to the operation request is normally completed.

The log storage processing unit 39 stores, as the log information 411, the log information 362 accumulated in the holding unit 36 in the log storage unit 41, in accordance with the result of confirmation by the confirmation processing unit 38.

In the confirmation by the confirmation processing unit 38, the following processes are performed in accordance with the received logs relating to the processing result.

(a) In case where processing result indicates an abnormal termination:

In this case, since it is determined that a series of processes in response to the operation request is abnormally terminated in the master CM 3, the confirmation processing unit 38 causes the log storage processing unit 39 to store the log information 362 relating to the operation request in the log storage unit 41. In addition, the confirmation processing unit 38 transmits response data indicating an abnormal termination to the master CM 3 through the communication unit 37.

(b) In case where processing result indicates a normal termination:

In this case, it is determined that a series of processes in response to the operation request is normally terminated in the master CM 3. However, for example, even in a case where the process itself is normally terminated in the master CM 3, the contents displayed on a GUI screen of the operation terminal 5 may be abnormal. Consequently, in a case where the processing result indicates “normal”, the confirmation processing unit 38 performs a normality confirmation process on the basis of the identifier information 361, the log information 362, and the normality confirmation information 363.

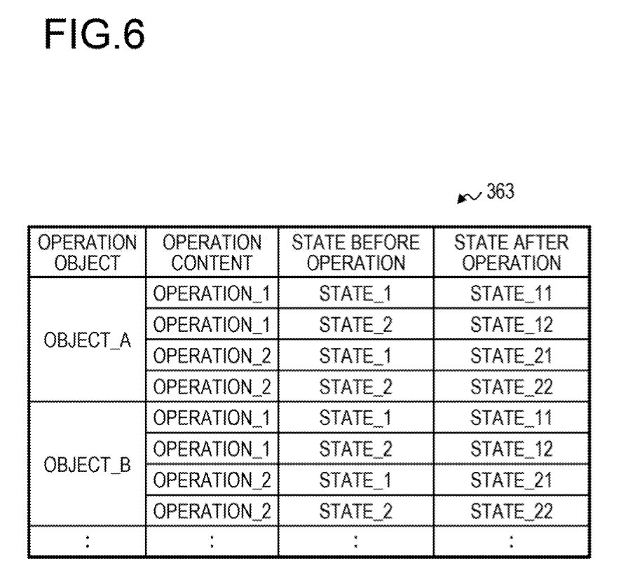

As illustrated in FIG. 6, an operation content, a state before an operation, and a state after an operation are set in the normality confirmation information 363 for each operation object specified by a GUI operation on the operation terminal 5. Together with the identifier information 311 and 361, the normality confirmation information 363 is preferably set in advance in the storage device 2 before the GUI operation is performed on the operation terminal 5.

As described above, with respect to a series of a plurality of processes executed by the master CM 3, the normality confirmation information 363 is an example of preset expectation information including a state before execution of the plurality of processes and a predicted state after the execution of the plurality of processes.

In the normality confirmation process, the confirmation processing unit 38 may perform, for example, the following processes of (i) to (iv).

(i) A series of logs relating to the operation request is extracted from the log information 362.

The confirmation processing unit 38 may extract logs corresponding to an identifier which is included in the log information 362 and which has two leading digits (e.g., “01”) relating to an operation content, as the logs relating to the operation request. Alternatively, using the identifier included in the log information 362, the confirmation processing unit 38 may search the identifier information 361 for an operation content corresponding to the identifier, and determine whether the detected operation content relates to the operation request, to thereby determine whether the logs corresponding to the identifier are logs relating to the operation request.

(ii) The normality confirmation information 363 is searched for an entry corresponding to a device state of an operation object before processing, which is obtained from the extracted logs, and the “state after operation” of the detected entry is acquired as an expected result.

(iii) The “current device state” relating to the operation object after processing by the master CM 3, which is included in the log information 362, and the “state after operation” (expected result) within the normality confirmation information 363 acquired in the above (ii) are compared with each other.

(iii-1) In a case where both of the states are coincident with each other as a result of comparison, the log information 362 is inhibited from being stored into the log storage unit 41.

In this case, the confirmation processing unit 38 may manage the log information 362 accumulated in the holding unit 36 as an over-writable state. Alternatively, the confirmation processing unit 38 may discard the log information 362 accumulated in the holding unit 36.

(iii-2) In a case where both of the states are not coincident with each other as a result of comparison, it is determined that a series of processes in response to the operation request in the master CM 3 is abnormal, and the log storage processing unit 39 is instructed to store the log information 362 into the log storage unit 41.

(iv) The determination result (“normal” or “abnormal”) of the above (iii) is responded to the master CM 3.

Using the above processes of (i) to (iv), the confirmation processing unit 38 may extract a state before processing by a plurality of processes from the log information 362, and acquire a corresponding state after operation included in the normality confirmation information 363 on the basis of the extracted state before processing. The confirmation processing unit 38 may determine a normal termination or an abnormal termination of the plurality of processes, in accordance with whether the state after operation acquired from the normality confirmation information 363 and the state after the execution of the plurality of processes included in the log information 362 are coincident with each other.

Thereby, since the normality of the log information 362 is determined on the basis of the normality confirmation information 363 predicted in advance, it is possible to accurately determine the normality of a series of a plurality of processes in the master CM 3.

Since a key for searching the normality confirmation information 363 may be extracted from the log information 362 on the basis of the identifier included in the log information 362, the confirmation processing unit 38 may easily execute the normality confirmation process.

The master CM 3 notified with an abnormality from the slave CM 3 may present a response result indicating “abnormal” to the operation terminal 5, and the slave CM 3 may acquire the log information 411 stored in the log storage unit 41 in response to a request from the operation terminal 5. The log information 411 is used in the inspection or analysis of a failure occurred in, for example, the master CM 3 or the operation terminal 5.

As described above, the confirmation processing unit 38 is an example of a determination unit that determines whether a plurality of processes are normally terminated, on the basis of the log information 362 and the normality confirmation information 363, in a case where the log information 362 includes information indicating that a series of a plurality of processes by the master CM 3 is normally terminated.

The log storage processing unit 39 is an example of a writing unit that writes the log information 362 into the log storage unit 41 different from the holding unit 36, in a case where the confirmation processing unit 38 as an example of the determination unit determines the abnormal termination of a plurality of processes.

As described above, according to the storage device 2 of the embodiment, it is possible that the master CM 3 collects and transmits a log to the slave CM 3-2, the slave CM 3 accumulates the transmitted log in the holding unit 36, and the slave CM 3 selectively stores the log information 362 into the log storage unit 41.

Therefore, the data used in an inspection or analysis when a failure is occurred may be stored as the log information 411 in the memory device 4 coupled with the slave CM 3 without influencing the process of the master CM 3. It is possible to suppress an increase in cost since hardware such as the memory 3b of the CM 3 does not need to be changed. In other words, it is possible to avoid a shortage in the storage area of the holding unit 31 of the master CM 3 for temporarily saving information used for determining a normality (“normal” or “abnormal”) of an operation.

In addition, the slave CM 3 also confirms normality with respect to an operation (a series of processes) determined to be “normally terminated” by the master CM 3, thereby allowing the actually abnormal log information 411 to be reliably accumulated in the log storage unit 41. In other words, since a normality (“normal” or “abnormal”) of the processing result in the master CM 3 may be determined not only in the master CM 3 but also in the slave CM 3, it is possible to store the appropriate log information 411 used in the inspection or analysis of a failure with a higher level of accuracy than in a case where the processing result is determined by the master CM 3 alone.

Next, an exemplary operation of the storage system 1 configured as described above will be described. In the following description, it is assumed that the CM 3-1 is the master CM 3, and that the CM 3-2 and other CMs 3 (hereinafter, simply referred to as slave CMs 3-2), not illustrated, are a plurality of slave CMs 3.

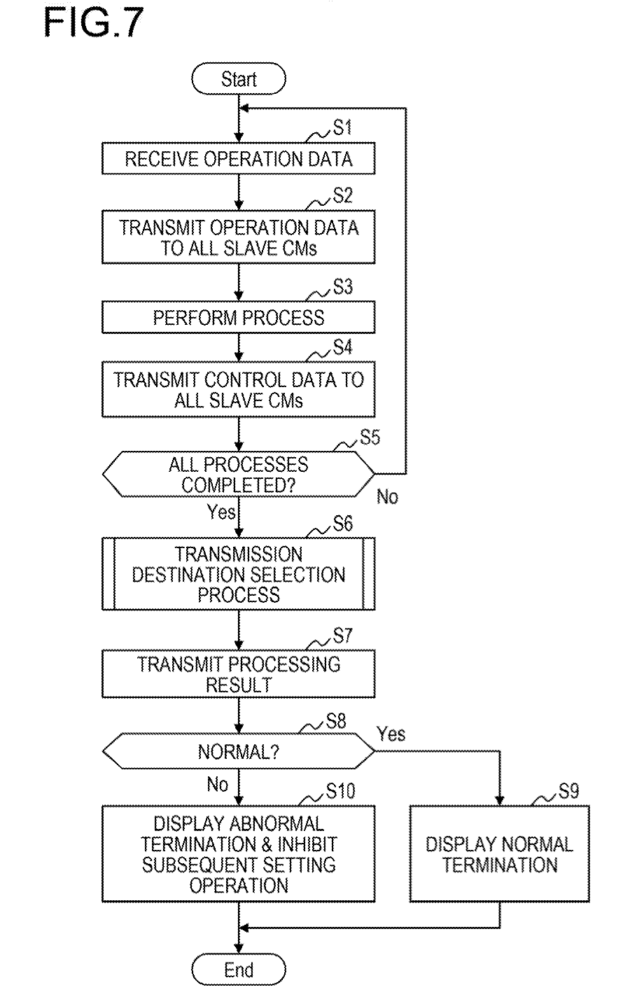

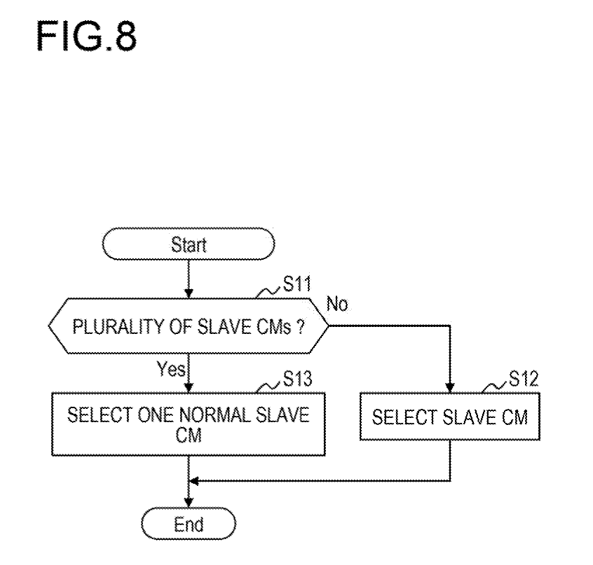

An exemplary operation of the master CM 3-1 will be described first with reference to FIGS. 7 and 8.

First, as illustrated in FIG. 7, when the communication unit 32 of the master CM 3-1 receives operation data from the operation terminal 5 through a GUI task of the master CM 3-1 (S1), the log transmission unit 34 transmits the received operation data to all the slave CMs 3-2 through the communication unit 32 (S2).

The operation processing unit 33 analyzes the operation data received from the operation terminal 5, and performs a process such as the acquisition of a device state of an operation object and reflection of setting in the device in accordance with the operation content (S3). The log transmission unit 34 transmits command data relating to communications with another module and control data such as internal control data relating to the generation, change, or the like of an internal table, which are occurred in the processes of S3, to the slave CM 3-2 through the communication unit 32 (S4).

In each of S2 and S4, the log transmission unit 34 acquires an identifier, corresponding to the data (operation data or control data) to be transmitted, from the identifier information 311, and adds the acquired identifier to the data (operation log) to be transmitted. In addition, in each of S2 and S4, the transmission destination selection unit 35 stores information indicating the accumulation status of the log information 362 in the slave CMs 3-2, which is included in the response data received from the slave CMs 3-2, into the holding unit 31 or the like.

S1 to S4 are repeatedly performed until a series of processes relating to the operation request from the operation terminal 5 is completed (No of S5), and the operation data and the control data generated during the processes are transmitted to the slave CMs 3-2. When a series of processes is completed (Yes of S5), the transmission destination selection unit 35 performs a transmission destination selection process (S6), and the log transmission unit 34 transmits a processing result to which an identifier is added, to the slave CM 3-2 selected by the transmission destination selection unit 35 (S7). When the processing result is transmitted, current state information relating to a device serving as an operation object is transmitted together.

Next, when the response data for the processing result is received from the slave CM 3-2, the master CM 3-1 determines whether the confirmation result of operation normality in the slave CM 3-2 indicates “normal” (S8). In a case where the confirmation result indicates “normal” (Yes of S8), the operation processing unit 33 displays normal termination on the screen of the operation terminal 5 (S9), and the process is terminated. S9 may be omitted.

In a case where the confirmation result indicates “abnormal” (No of S8), the operation processing unit 33 notifies an operator of the occurrence of abnormality by displaying the abnormal termination on the screen of the operation terminal 5, and inhibits the subsequent setting operation (S10). Thereafter, the process is terminated.

Next, reference will be made to FIG. 8 to describe a transmission destination selection process (S6 of FIG. 7) which is performed by the transmission destination selection unit 35.

The transmission destination selection unit 35 determines whether a plurality of slave CMs 3-2 are present in the storage device 2, for example, with reference to configuration information of the storage device 2 (S11). In a case where only one slave CM 3-2 is present (No of S11), the transmission destination selection unit 35 selects the only one slave CM 3-2 (S12), and the transmission destination selection process is terminated.

In a case where a plurality of slave CMs 3-2 are present (Yes of S11), the transmission destination selection unit 35 selects one slave CM 3-2 on the basis of the response data stored in the holding unit 31 or the like, in S2 and S4 of FIG. 7 (S13), and the transmission destination selection process is terminated. As an example, the transmission destination selection unit 35 selects one normal slave CM 3-2 that stores all the operation logs, on the basis of the information indicating the accumulation status of the log information 362 in the slave CM 3, which is included in the response data.

In a case where there is only one slave CM 3-2 serving as a transmission destination of a log, S6 and the storage of the response data in the holding unit 31 in S2 and S4 may be omitted.

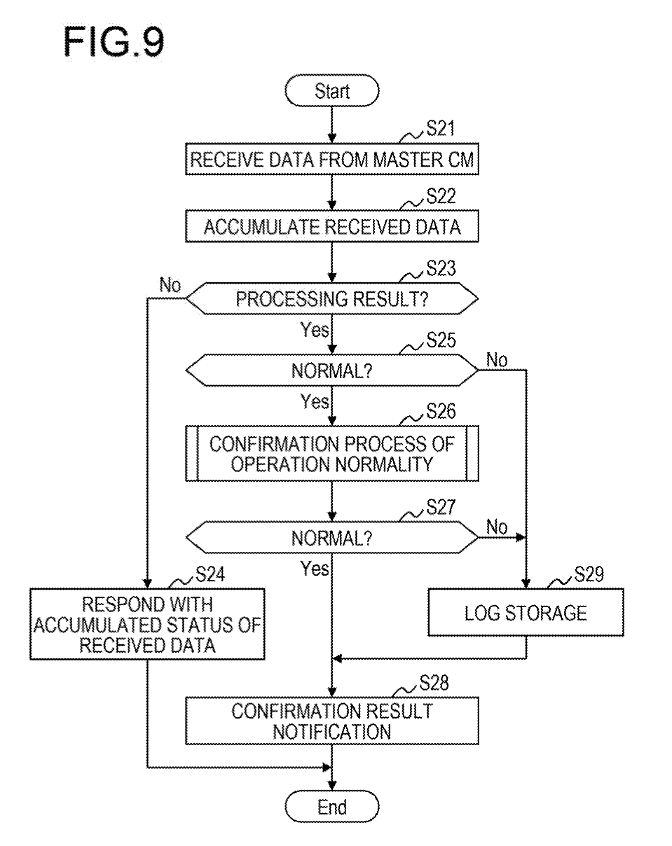

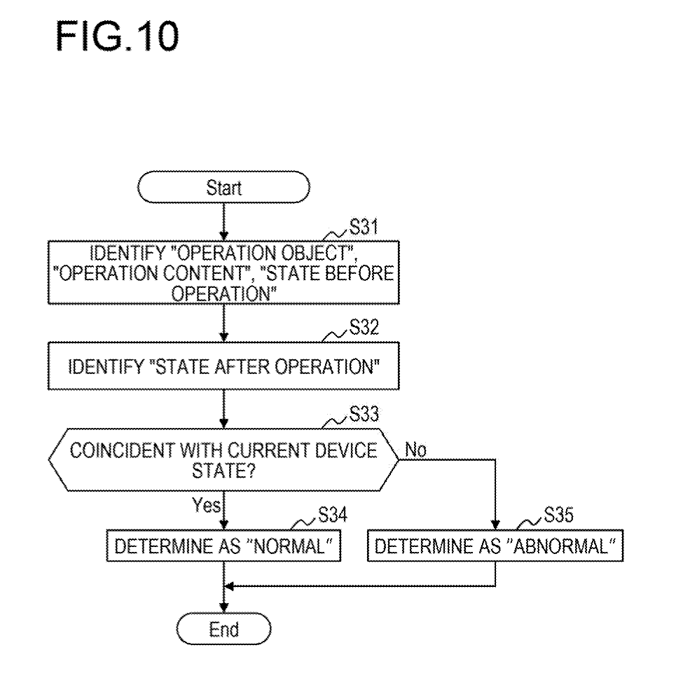

Next, an exemplary operation of the slave CM 3-2 will be described with reference to FIGS. 9 and 10.

First, as illustrated in FIG. 9, when the data transmitted from the master CM 3-1 is received (S21), the communication unit 37 of the slave CM 3-2 accumulates the received data as the log information 362 in the log accumulation area of the holding unit 36 (S22). In the storage of the log information 362 in the holding unit 36, the communication unit 37 may use the storage area for operation data in the holding unit 36 in order from the head thereof, and use the storage area from the head again when the area has been used until the end thereof.

The slave CM 3-2 determines whether the received data is a processing result (S23). In a case where the received data is other than a processing result (No of S23), the communication unit 37 transmits the information indicating the accumulation status of the log information 362 in the slave CM 3, as a response to the master CM 3-1 (S24), and the process is terminated. The slave CM 3-2 waits for the reception of new data from the master CM 3-1. In a case where there is only one slave CM 3-2 serving as a transmission destination of a log, S24 will be omitted.

In a case where the received data is a processing result (Yes of S23), the communication unit 37 determines whether the processing result indicates “normal” (S25). In a case where the processing result indicates “normal” (Yes of S25), the confirmation processing unit 38 performs the process of confirming operation normality (S26), and determines whether the confirmation result indicates “normal” (S27).

In a case where the confirmation result indicates “normal” (Yes of S27), the confirmation processing unit 38 transmits the confirmation result of operation normality (“normal” in this case) to the master CM 3-1 through the communication unit 37 (S28), and the process is terminated.

In a case where the confirmation result indicates “abnormal” (No of S27), the confirmation processing unit 38 instructs the log storage processing unit 39 to store the log information 362 in the log storage unit 41, and the log storage processing unit 39 stores the log information 362 as the log information 411 in the log storage unit 41 (S29). The process then proceeds to S28. In S28 via S29, the confirmation processing unit 38 transmits the confirmation result of operation normality (“abnormal” in this case) to the master CM 3-1 through the communication unit 37.

Next, the process of confirming operation normality (S26 of FIG. 9) which is performed by the confirmation processing unit 38 will be described with reference to FIG. 10.

In the process of confirming the operation normality, the confirmation processing unit 38 searches the operation data and the control data of the log information 362 within the log accumulation area, and identifies an “operation object”, “operation content”, and a “state before operation” (S31).

Next, the confirmation processing unit 38 searches the normality confirmation information 363 using the “operation object”, the “operation content”, and the “state before operation” identified in S31 as keys, and identifies a “state after operation” as an expected result (S32).

The confirmation processing unit 38 then compares the “state after operation” identified as the expected result with the “current device state” received from the master CM 3-1 together with the processing result (S33).

In a case where the comparison result indicates “coincidence” (Yes of S33), the confirmation processing unit 38 determines that an operation in the master CM 3 is normal, for example, the operation is normally terminated (S34), and the confirmation process is terminated.

In a case where the comparison result indicates “non-coincidence” (No of S33), the confirmation processing unit 38 determines that the operation in the master CM 3 is abnormal, for example, the operation is abnormally terminated (S35), and the confirmation process is terminated.

Next, an application example of the storage system 1 configured as described above will be described. Hereinafter, descriptions will be given by taking an example of a case where an operation request for RAID capacity expansion is issued from the operation terminal 5 to the master CM 3-1, and the master CM 3-1 performs a series of processes relating to the RAID capacity expansion.

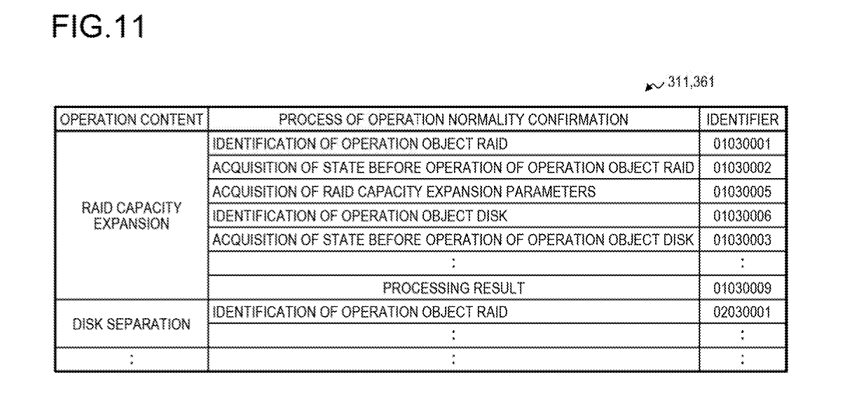

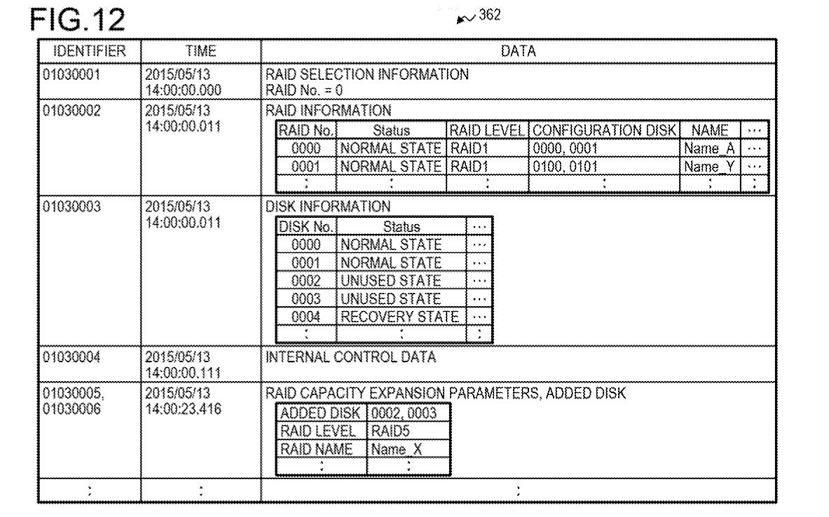

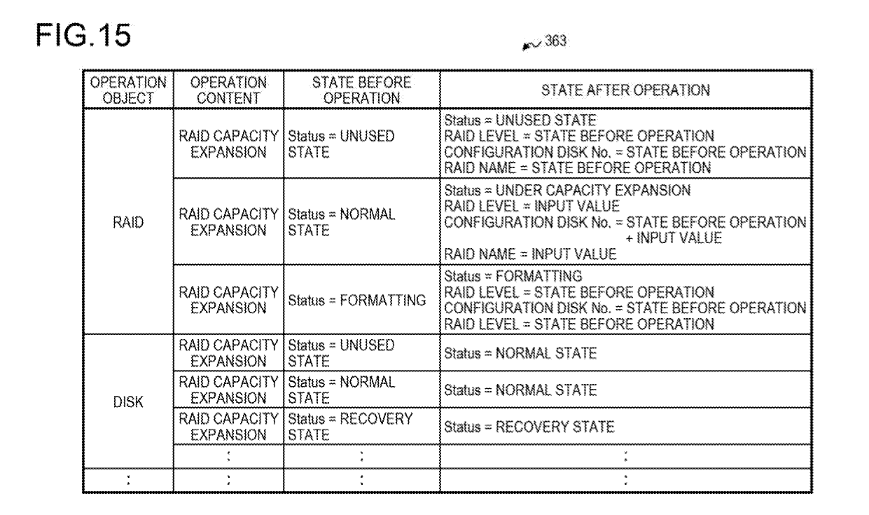

The function of the RAID capacity expansion is a function of adding a new disc to the existing RAID to expand the storage capacity of the RAID. The identifier information 311 and 361 stored in advance in the master CM 3-1 and the slave CM 3-2 is illustrated FIG. 11. The log information 362 generated (accumulated) by the slave CM 3-2 is illustrated in FIGS. 12 to 14, and the normality confirmation information 363 stored in advance in the slave CM 3-2 is illustrated FIG. 15.

In such an assumption, it is assumed that a user (operator) selects a RAID (for example, “RAID No. 0”) serving as an operation object from the GUI screen of the operation terminal 5 coupled with the master CM 3-1, and the operation of the RAID capacity expansion is started.

In this case, the master CM 3-1 receives RAID number “0” as an operation object (RAID selection information) from the operation terminal 5. The information of the operation object is set to the “RAID capacity expansion” of the “operation content” and the “identification of operation object RAID” of the “process of operation normality confirmation” in the identifier information 311, and a corresponding “identifier” is “01030001”. Therefore, the master CM 3-1 transmits the “RAID No. 0” as an operation object (RAID selection information) to the slave CM 3-2 together with the identifier “01030001”.

The slave CM 3-2 stores the identifier “01030001” received from the master CM 3-1, information of an operation object, and a time stamp, as the log information 362, to the holding unit 36 (see an entry of the identifier “01030001” in FIG. 12).

Next, the master CM 3-1 acquires RAID information which is the state before an operation for the operation object RAID and disc information which is the state before an operation for an operation object disc, both of which are held in the master CM 3-1, and generates an input screen for inputting parameters to display the generated screen on the display screen of the operation terminal 5. In this case, the master CM 3-1 adds an identifier “01030002” to the RAID information, adds an identifier “01030003” to the disc information, and adds an identifier “01030004” as internal control data to the generation of the input screen, on the basis of the identifier information 311, to transmit the respective information to the slave CM 3-2.

The slave CM 3-2 stores the identifiers “01030002” to “01030004” received from the master CM 3-1, each corresponding information, and a time stamp, as the log information 362, in the holding unit 36 (see entries of the identifiers “01030002” to “01030004” in FIG. 12). A table of the RAID information and the disc information included in the entries of the identifiers “01030002” and “01030003” of FIG. 12 may also be displayed on the operation terminal 5.

Next, a user inputs information such as an added disc, a RAID level, and a RAID name from the input screen of the operation terminal 5, and executes the operation of the RAID capacity expansion.

In this case, the master CM 3-1 acquires the information such as the RAID level and the RAID name as RAID capacity expansion parameters (identifier “01030005”), and identifies the added disc as an operation object disc (identifier “01030006”). The master CM 3-1 then adds the identifiers “01030005” and “01030006” to information of the RAID capacity expansion parameters and the operation object disc on the basis of the identifier information 311, and transmits the respective information to the slave CM 3-2. The respective information may be separately transmitted for each identifier.

The slave CM 3-2 stores the identifiers “01030005” and “01030006” received from the master CM 3-1, each corresponding information, and a time stamp, as the log information 362, in the holding unit 36 (see entries of the identifiers “01030005” and “01030006” in FIG. 12). The table of the RAID capacity expansion parameters and the operation object disc included in the entries of the identifiers “01030005” and “01030006” of FIG. 12 may also be displayed on the operation terminal 5.

The master CM 3-1 instructs a device serving as an operation object to perform change of the setting, in accordance with the input information in the operation terminal 5. In this case, the master CM 3-1 adds an identifier “01030007” to the internal control data, and adds an identifier “01030008” to the command data, on the basis of the identifier information 311, to transmit the respective information to the slave CM 3-2.

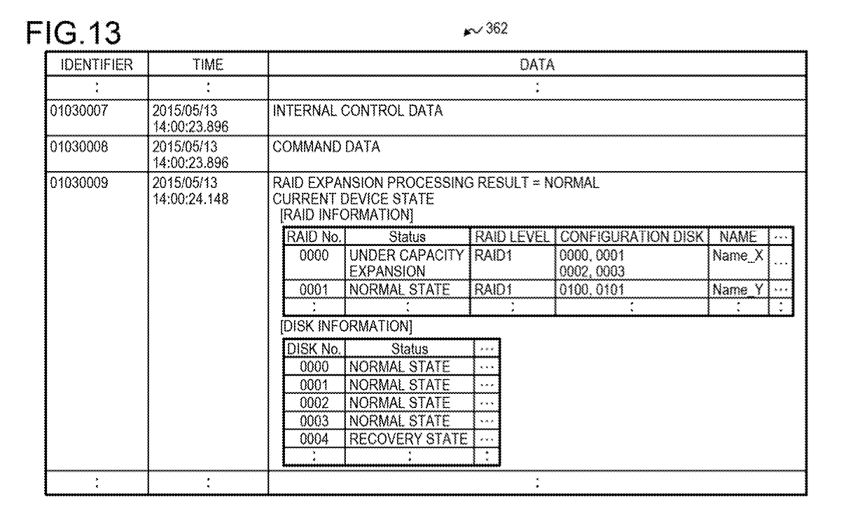

The slave CM 3-2 stores the identifiers “01030007” and “01030008” received from the master CM 3-1, each corresponding information, and a time stamp, as the log information 362, in the holding unit 36 (see entries of the identifiers “01030007” and “01030008” in FIG. 13).

Next, the master CM 3-1 adds an identifier “01030009” to a processing result (“normal” or “abnormal”) of instructing the device serving as an operation object to perform change of the setting, and a device state after the instruction of change of the setting, on the basis of the identifier information 311, to transmit the information to the slave CM 3-2.

The slave CM 3-2 stores the identifier “01030009” received from the master CM 3-1, corresponding information, and a time stamp, as the log information 362, in the holding unit 36 (see an entry of the identifier “01030009” in FIG. 13).

The slave CM 3-2 identifies that the received identifier “01030009” indicates the processing result, on the basis of the identifier information 361. In this case, the slave CM 3-2 refers to the log information 362 of the identifier “01030009”, and performs the process of confirming operation normality which is performed by the confirmation processing unit 38 as the processing result is normal (see FIG. 13).

Hereinafter, descriptions will be given of a confirmation process in a case where the slave CM 3-2 receives a log of the identifier “01030009” illustrated in FIG. 13.

The confirmation processing unit 38 of the slave CM 3-2 searches the log information 362 in the log accumulation area, and refers to data of a first identifier relating to the operation request corresponding to the identifier “01030009”, for example, first operation data out of identifiers beginning with “01” relating to the RAID capacity expansion function. In this case, the confirmation processing unit 38 refers to the identifier “01030001”, and identifies an operation object “RAID” and operation data of “RAID No. 0”.

An example of the first identifier includes an earliest-numbered identifier defined in the identifier information 361. In addition, when identifiers are referred to, on the assumption of a case where information of the same identifier is input from the operation terminal 5 multiple times, the data of an identifier having a newest time is preferably referred to among the identifier to be referred to.

Subsequently, the confirmation processing unit 38 identifies “Status=normal state” and “configuration disc=0000, 0001” from the operation data of the identifiers “01030002” and “01030003” of the log information 362, as a state before an operation of the “RAID No 0”. Thereby, the keys for searching the normality confirmation information 363 are set to the operation object “RAID”, the operation content “RAID capacity expansion”, and the state before an operation “Status=normal state”.

The confirmation processing unit 38 searches the normality confirmation information 363 using the keys obtained by the above process, and identifies a state of a corresponding entry after an operation “Status=under capacity expansion”, “RAID level=input value”, “configuration DISK No=state before operation (0000, 0001)+input value”, and “RAID name=input value”, as an expected result (see FIG. 15).

In the examples illustrated in FIGS. 12 and 13, since an input value is included in the expected result, the confirmation processing unit 38 searches the log information 362 in the log accumulation area, refers to operation data having a newest time relating to the identifiers “01030005” and “01030006”, and identifies the expected result as follows.

<Expected result of “RAID No. 0”>
“Status=under capacity expansion”
“RAID level=RAID5”
“Configuration DISK No.=0000, 0001, 0002, 0003”
“RAID name=Name_X”

Even in a case where the operation object is a disc, the confirmation processing unit 38 identifies the expected result as follows, in the same procedure as described above.

<Expected result of “DISK No. 2”>
“Status=normal state”

<Expected result of “DISK No. 3”>
“Status=normal state”

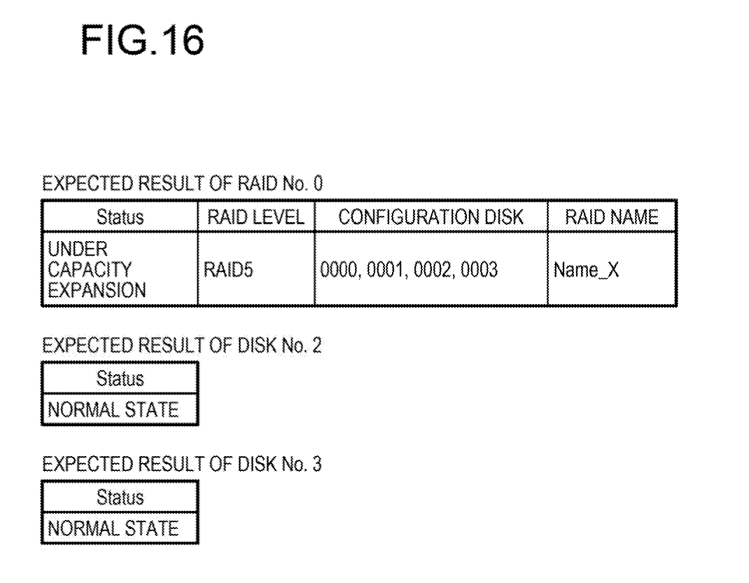

Based on the above processes, the expected result of the operation normality confirmation by the confirmation processing unit 38 are set to be in a state illustrated in FIG. 16.

The confirmation processing unit 38 compares the expected result obtained as described above with the state information (see FIG. 13) of the current device stored in the processing result (identifier “01030009”) received from the master CM 3-1, and determines that an operation is normal (normally terminated) since the comparison result indicates “coincidence”. In this case, the confirmation processing unit 38 notifies the master CM 3-1 of normal termination as the confirmation result of operation normality.

Since it is determined that the operation in the master CM 3-1 is normally terminated, the slave CM 3-2 inhibits the log information 362 from being written into the log storage unit 41. In this case, the log information 362 stored in the holding unit 36 is overwritten by the subsequent accumulation or the like of new logs in the log accumulation area.

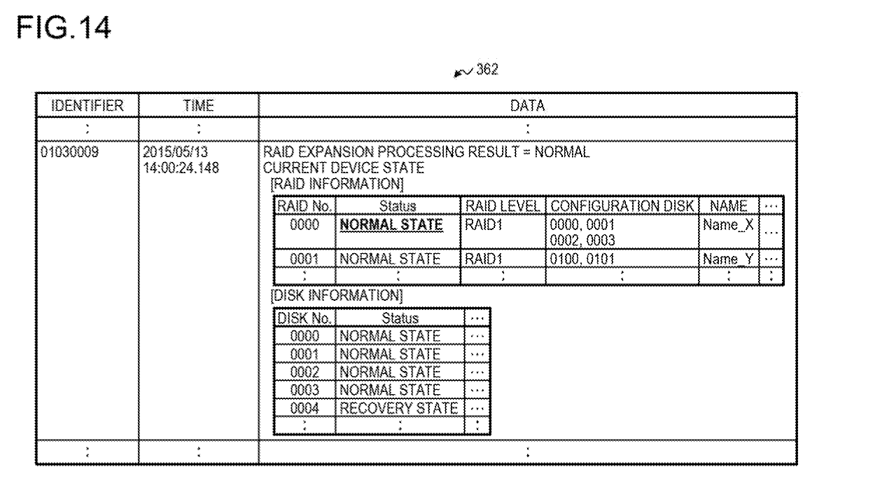

Another example of the state information of the current device stored in the processing result (identifier “01030009”) received from the master CM 3-1 is illustrated in FIG. 14. FIG. 14 illustrates “Status=normal state” in the “RAID No. 0(0000)” in the state information of the current device.

In the example illustrated in FIG. 14, since the expected result and the state information of the current device are not coincident with each other, the confirmation processing unit 38 determines that the operation is abnormal (abnormally terminated). In this case, the confirmation processing unit 38 causes the log storage processing unit 39 to write the log information 362 within the log accumulation area into the log storage unit 41, and notifies the master CM 3-1 of abnormal termination as the confirmation result of operation normality.

When the confirmation result of operation normality is received, the master CM 3-1 causes the operation terminal 5 to display normal termination or abnormal termination in accordance with the confirmation result, and inhibits the subsequent setting operation in a case where the master CM 3-1 is notified of abnormal termination. The process is then terminated.

In this manner, the method according to the embodiment is applied to the master CM 3-1 and the slave CM 3-2. Thereby, the slave CM 3-2 determines whether a series of processes, which are determined to be normal by the master CM 3-1, is normal and may store the relevant log information 362 in the log storage unit 41 in a case of determining the series of processes to be abnormal. Therefore, the appropriate log information 411 capable of being used in the inspection or analysis of a failure cause may be stored in the log storage unit 41 without being lost.

The technique according to the embodiment described above may be modified and changed as follows.

For example, the respective functional blocks of the CM 3 illustrated in FIG. 3 may be merged with each other by any combination thereof, and may be divided.

The storage system 1 is assumed to include two CMs 3, but the storage system 1 may be provided with N (N is any natural number) CMs 3, without being limited thereto.

Descriptions have been given on a case where the operation terminal 5 accesses the master CM 3-1 through a GUI, but there is no limitation thereto, and the operation terminal 5 may access the master CM 3-1 through a character user interface (CUI) or the like.

In the embodiment, descriptions have been given on the exemplary operations of the master CM 3-1 and the slave CM 3-2 in a case where the master CM 3-1 performs processes in accordance with the operation request from the operation terminal 5, but there is no limitation thereto. For example, even in a case where processes are performed in accordance with various other requests from other devices, such as a case where the master CM 3-1 performs processes in accordance with the access request from the host device 6, the method according to the embodiment may be applied similarly.

In the embodiment, descriptions have been given on a case where the master CM 3-1 executes a series of a plurality of processes, and the slave CM 3-2 accumulates and stores the log information 362, but there is no limitation thereto. For example, even in a case where the slave CM 3-2 executes a series of a plurality of processes, and the master CM 3-1 accumulates and stores the log information 362, the method according to the embodiment may be applied similarly. Even in a case where a plurality of CMs 3 have an equal relationship, the method according to the embodiment may be applied similarly between these CMs 3 (e.g., between a plurality of slave CMs 3).

In addition, the method according to the embodiment may be applied to a plurality of control devices in various information processing systems, without being limited to a plurality of CMs 3 in the storage device 2.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has (have) been described in detail, it should be understood that the various changes, substitutions, and alterations could be made hereto without departing from the spirit and scope of the invention.

What is claimed is:

1. A control device, comprising:
a memory device configured to
store therein log information obtained by accumulating logs received from an apparatus, the logs relating to a series of a plurality of processes executed by the apparatus; and
a processor configured to
receive the logs from the apparatus,
accumulate the received logs to obtain the log information,
store the obtained log information into the memory device,
determine on basis of the log information and preset expectation information whether the plurality of processes are normally terminated in a case where the log information includes information indicating that the plurality of processes are normally terminated, the expectation information including first state information in association with expected state information, the first state information indicating a first state of an object before execution of the plurality of processes, the expected state information indicating an expected state of the object after the execution of the plurality of processes, and
write the log information into a storage device different from the memory device upon determining that the plurality of processes are abnormally terminated.

2. The control device according to claim 1, wherein
the log information includes the first state information and second state information indicating a second state of the object after the execution of the plurality of processes, and
the processor is configured to
extract the first state information included in the log information,
acquire the second state indicated by the second state information included in the log information,
acquire the expected state indicated by the expected state information which is associated with the extracted first state information in the expectation information,
determine whether the acquired expected state and the acquired second state are coincident with each other, and
determine that the plurality of processes are abnormally terminated in a case where the acquired expected state and the acquired second state are determined to be non-coincident with each other.

3. The control device according to claim 2, wherein
the plurality of processes include a first process of acquiring a state of the object and a second process of changing the acquired state of the object,
the log information includes a first log relating to the first process and a second log relating to the second process, and
the processor is configured to
extract the first state information on basis of the first log, and
acquire the second state on basis of the second log.

4. The control device according to claim 3, wherein
the respective logs received from the apparatus are added with an identifier by the apparatus on basis of preset identifier information including each content of the plurality of processes in association with a corresponding identifier, and
the processor is configured to
extract the first log and the second log from the log information on basis of the identifier information.

5. The control device according to claim 1, wherein
the processor is configured to
inhibit the writing of the log information upon determining that the plurality of processes are normally terminated.

6. The control device according to claim 1, wherein
the processor is configured to
write the log information into the storage device in a case where the log information includes information indicating that the plurality of processes are abnormally terminated.

7. An information processing system, comprising:
a first control device including:
a first processor configured to
execute a series of a plurality of processes, and
transmit logs relating to the plurality of processes; and
one or more second control devices each including:
a memory device configured to
store therein log information obtained by accumulating the logs received from the first control device, and
a second processor configured to
receive the logs from the first control device,
accumulate the received logs to obtain the log information,
store the obtained log information into the memory device,
determine on basis of the log information and preset expectation information whether the plurality of processes are normally terminated in a case where the log information includes information indicating that the plurality of processes are normally terminated, the expectation information including first state information in association with expected state information, the first state information indicating a first state of an object before execution of the plurality of processes, the expected state information indicating an expected state of the object after the execution of the plurality of processes, and
write the log information into a storage device different from the memory device upon determining that the plurality of processes are abnormally terminated.

8. The information processing system according to claim 7, wherein
the log information includes the first state information and second state information indicating a second state of the object after the execution of the plurality of processes, and
the second processor is configured to
extract the first state information included in the log information,
acquire the second state indicated by the second state information included in the log information,
acquire the expected state indicated by the expected state information which is associated with the extracted first state information in the expectation information,
determine whether the acquired expected state and the acquired second state are coincident with each other, and
determine that the plurality of processes are abnormally terminated in a case where the acquired expected state and the acquired second state are determined to be non-coincident with each other.

9. The information processing system according to claim 8, wherein
the plurality of processes include a first process of acquiring a state of the object and a second process of changing the acquired state of the object,
the log information includes a first log relating to the first process and a second log relating to the second process, and
the second processor is configured to
extract the first state information on basis of the first log, and
acquire the second state on basis of the second log.

10. The information processing system according to claim 9, wherein
the first processor is configured to
add an identifier to the respective logs on basis of preset identifier information including each content of the plurality of processes in association with a corresponding identifier, and
the second processor is configured to
extract the first log and the second log from the log information on basis of the identifier information.

11. The information processing system according to claim 7, wherein
the second processor is configured to
inhibit the writing of the log information upon determining that the plurality of processes are normally terminated.

12. The information processing system according to claim 7, wherein
the second processor is configured to
write the log information into the storage device in a case where the log information includes information indicating that the plurality of processes are abnormally terminated.

13. The information processing system according to claim 7, wherein
the second processor is configured to
transmit accumulation information indicating an accumulation status of accumulating the logs to the first control device, and
the first processor is configured to
receive the accumulation information from each of the one or more second control devices,
select at least one second control device on basis of the received accumulation information, and
transmit information indicating whether or not the plurality of processes are normally terminated to the selected second control device.

14. A non-transitory computer-readable recording medium having stored therein a program that causes a computer to execute a process, the process comprising:
receiving logs from an apparatus, the logs relating to a series of a plurality of processes executed by the apparatus;
accumulating the received logs to obtain the log information;
storing the obtained log information into a memory device;
determining on basis of the log information and preset expectation information whether the plurality of processes are normally terminated in a case where the log information includes information indicating that the plurality of processes are normally terminated, the expectation information including first state information in association with expected state information, the first state information indicating a first state of an object before execution of the plurality of processes, the expected state information indicating an expected state of the object after the execution of the plurality of processes; and
writing the log information into a storage device different from the memory device upon determining that the plurality of processes are abnormally terminated.

15. The non-transitory computer-readable recording medium according to claim 14, wherein
the log information includes the first state information and second state information indicating a second state of the object after the execution of the plurality of processes, and
the process further comprises:
extracting the first state information included in the log information;
acquiring the second state indicated by the second state information included in the log information;
acquiring the expected state indicated by the expected state information which is associated with the extracted first state information in the expectation information;
determining whether the acquired expected state and the acquired second state are coincident with each other; and
determining that the plurality of processes are abnormally terminated in a case where the acquired expected state and the acquired second state are determined to be non-coincident with each other.

16. The non-transitory computer-readable recording medium according to claim 15, wherein
the plurality of processes include a first process of acquiring a state of the object and a second process of changing the acquired state of the object,
the log information includes a first log relating to the first process and a second log relating to the second process, and
the process further comprises:
extracting the first state information on basis of the first log; and
acquiring the second state on basis of the second log.

17. The non-transitory computer-readable recording medium according to claim 16, wherein
the respective logs received from the apparatus are added with an identifier by the apparatus on basis of preset identifier information including each content of the plurality of processes in association with a corresponding identifier, and
the process further comprises:
extracting the first log and the second log from the log information on basis of the identifier information.

18. The non-transitory computer-readable recording medium according to claim 14, the process further comprising:
inhibiting the writing of the log information upon determining that the plurality of processes are normally terminated.

19. The non-transitory computer-readable recording medium according to claim 14, the process further comprising:
writing the log information into the storage device in a case where the log information includes information indicating that the plurality of processes are abnormally terminated.
